(19) United States
(12) Patent Application Publication
(10) Pub. No.: US 2015/0240845 A1
(43) Pub. Date: Aug. 27, 2015

(54) PROFILE CLAMP

(71) Applicant: NORMA GERMANY GMBH, Maintal (DE)

(72) Inventors: Stephan MANN, Biebergemuend (DE); Manfred KRUEGER, Buedingen (DE)

(73) Assignee: NORMA GERMANY GMBH, Maintal (DE)

(21) Appl. No.: 14/579,333

(22) Filed: Dec. 22, 2014

(30) Foreign Application Priority Data
Feb. 24, 2014 (DE) 10 2014 102 356.0

(51) Int. Cl. F16B 2/08

(52) U.S. Cl. CPC F16B 2/08

(57) ABSTRACT

A profile clamp (1) is disclosed with an annular clamping band (2) that comprises on its axial ends flanks sloped radially inwards and in the region of its circumferential ends respectively one tensioning head (5, 6), wherein the tensioning heads (5, 6) can be tightened towards one another by a head (8) of a threaded bolt (7) and a mating thread element (9).

The object is to specify a profile clamp with which a reliable coned flange connection is possible even at changing temperatures.

For this purpose, it is provided that at least one spacer piece (10) is arranged between the head (8) and the mating thread element (9).

### CROSS REFERENCE TO RELATED APPLICATIONS

The present application claims priority under 35 U.S.C. § 119(a) of German Patent Application No. 10 2014 102 356.0 filed Feb. 24, 2014, the disclosure of which is expressly incorporated by references herein in its entirety.

### BACKGROUND OF THE INVENTION

1. Field of the Invention

The invention relates to a profile clamp with an annular clamping band that comprises on its axial ends flanks sloped radially inwards and in the region of its circumferential ends respectively one tensioning head, wherein the tensioning heads can be tightened towards one another by a head of a threaded bolt and a mating thread element.

2. Discussion of Background information

A profile clamp of this type is for example used to form a coned flange connection. In a coned flange connection, the elements that are to be connected to one another comprise on their front faces that are to be connected respectively one flange that is sloped on its side facing away from the respective other element. The profile clamp is then positioned around the two flanges such that the sloped flanks of the clamping band bear against the sloped rear sides of the flanges. If the clamp is then tightened, the diameter of the clamping band is decreased and the sloped flanges apply an axial tension force on the flanges. The tightening of the clamping band occurs in that the threaded bolt and the mating thread element, for example, a threaded nut, are rotated towards one another and the distance between the two tensioning heads is thus decreased. By means of this decrease in distance, the inner diameter of the clamping band is also decreased.

A coned flange connection is often used in an exhaust gas line system of a motor vehicle, in order to connect the individual elements of the exhaust gas line, for example pipes and mufflers, to one another. An exhaust gas line system of a motor vehicle reaches an increased temperature during the operation of the motor vehicle. The increased temperature leads to a thermal expansion of elements, for example, including the coned flanges. This thermal expansion also causes an expansion of the clamping band and of the threaded bolt, which expansion may no longer revert after a cooling. Thus, there exists the risk of the profile clamp coming loose. This results in an undesired rattling and, in the extreme case, even in a loss of the profile clamp, so that the parts of the exhaust gas line system are no longer held together with the necessary certainty.

### SUMMARY OF THE EMBODIMENTS

Embodiments of the invention are directed to a profile clamp with which a reliable coned flange connection is possible even at changing temperatures,

According to embodiments, a profile clamp of the type named at the outset in-that includes at least one spacer piece is arranged between the head and the mating thread element,

With the spacer piece, it is possible to tighten the head of the threaded bolt and the mating thread element to the limit, A geometrically defined form is thus achieved which, even in the case of a change in temperature, does not, at least in the region of the threaded bolt, change in such a manner that the threaded bolt can come loose. Despite the ability to tighten the threaded bolt to the limit, the spacer piece creates a sufficient clamping length so that the threaded bolt can adequately expand according to its spring constants in order to produce the necessary tension force that also protects against a loosening of the threaded bolt. It is not absolutely necessary that the head be embodied in one piece with the threaded bolt, For example, it can also be screwed onto the threaded bolt,

Preferably, the spacer piece surrounds a threaded section of the threaded bolt, It is thus possible to support the head of the threaded bolt and the mating thread element in a planar manner, as it were. A tilting of the head or the mating thread element is thus prevented.

Preferably, the spacer piece is arranged between the tensioning heads, If the threaded bolt and the mating thread element are tightened towards one another, then they can clamp the tensioning heads between themselves and the spacer piece.

Preferably, the spacer piece comprises on its radially inner side flanks sloped radially inwards, The radial inside of the spacer piece can thus, at least for the most part, be adapted to the cross-section profile of the clamping band, so that an axial tension force can also be applied to the coned flanges in the region of the threaded bolt.

Advantageously, in the untightened state at least one tensioning head is tilted relative to the spacer piece such that the tensioning head initially comes to bear against the spacer piece on the radially outer side during tightening, Through the tightening of the threaded bolt, that is, the rotation of the threaded bolt relative to the mating thread element, the clamping band is then further tightened so that relatively large axial clamping or tension forces can be applied to the coned flanges here.

Preferably, at least one tensioning head is embodied in an open manner on the radially outer side, This simplifies production, The tensioning heads no longer require limit zones facing one another on their radial outside,

In an alternative embodiment, it can be provided that the spacer piece is arranged on the outside of a tensioning head. If multiple spacer pieces are provided, then they can of course be arranged on the outside of both tensioning heads, In this case, the spacer pieces provide a sufficient clamping length and thus an adequate extensibility of the threaded bolt,

Preferably, the spacer piece is embodied as a bent metal sheet part, This simplifies production. A bent metal sheet part can also be produced without considerable material loss and therefore cost-effectively. The bending of a metal sheet allows a relatively large number of options for shaping.

Preferably, the spacer piece has a polygonal cross section. This facilitates installation. The spacer piece can then be aligned at the tensioning heads, for example.

Preferably, the spacer piece is connected to a tensioning head. The spacer piece is then held captively on the profile clamp so that it is no longer necessary to make sure that the spacer piece is present during installation.

One option for this is that the spacer piece is formed from the tensioning head. The tensioning head is normally formed form a metal sheet. This metal sheet can then be deformed in such a manner that the spacer piece which surrounds the threaded bolt is produced.

An alternative is that the spacer piece is hooked into the tensioning head. The captivation is then produced in that the threaded bolt is guided through the tensioning head and through the spacer piece. If desired or necessary, the threaded bolt can then be secured against being pulled out in the spacer sleeve with a retaining ring,

### BRIEF DESCRIPTION OF THE DRAWINGS

The invention is described below on the basis of preferred exemplary embodiments in connection with the drawing, Wherein:

FIG. 1 shows a schematic sectional view through a profile clamp;

FIG. 2 shows a section 1141 according to FIG. 1;

FIG. 3 shows a top view of tensioning heads of the profile clamp;

FIG. 4 shows a section IV-IV according to FIG. 1;

FIG. 5 shows an embodiment modified over FIG. 4;

FIG. 6 shows a modified embodiment of tensioning heads during tightening;

FIG. 7 shows a further modified embodiment with a hooked-in spacer piece; and

FIGS. 8a 8c show views of another modified embodiment of the spacer piece,

### DETAILED DESCRIPTION OF THE EMBODIMENTS

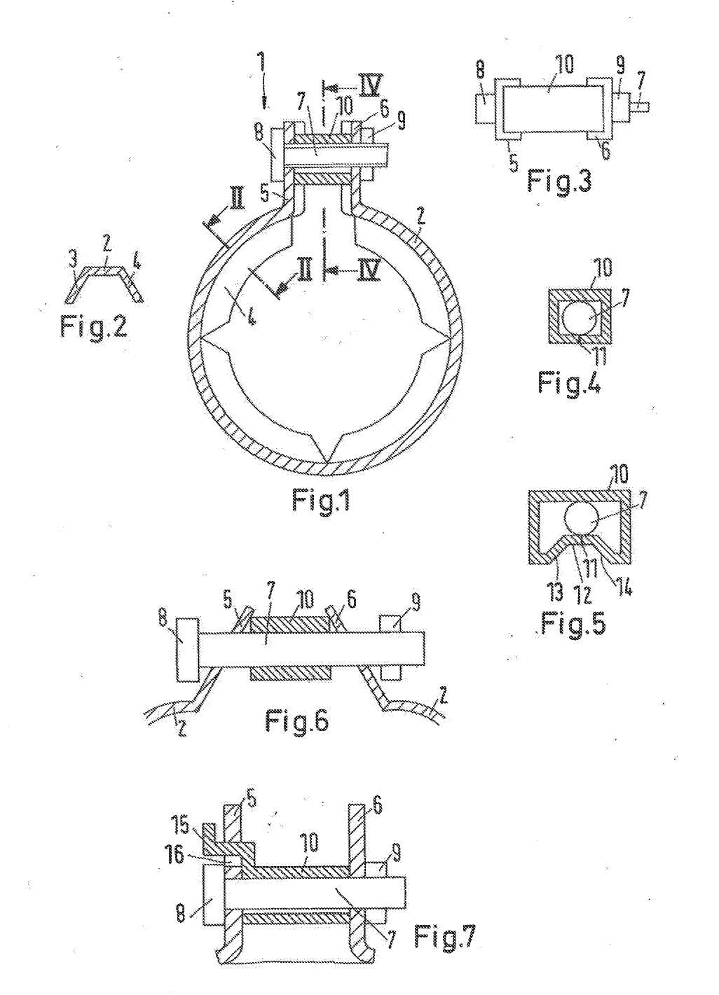

FIG. 1 shows in schematic view a profile damp l with a clamping band 2 that is bent to form a ring. The clamping band 2 comprises, as can be seen in FIG. 2, flanks 3, 4 sloped radially inwards which can be bent down radially inwards from the damping band 2. The flanks 3, 4 are, as can be seen in FIG. 1, interrupted once or multiple times in a circumferential direction, so that the clamping band 2 can be bent open.

The damping band 2 comprises on its two circumferential ends respectively one tensioning head 5, 6. The tensioning heads 5, 6 are bent back radially outwards from the clamping band 2.

A threaded bolt 7 with a head 8 is guided through the two tensioning heads 5, 6 and is screwed together with a mating thread element. The mating thread element 9 can, for example, be formed by a threaded nut. The head 8 can also be formed by a threaded nut.

Between the two tensioning heads 5, 6, a spacer piece 10 is arranged which in the present case is embodied as a sleeve which surrounds a threaded section of the threaded bolt 7.

For the installation of the profile clamp 1, the screw connection between the threaded bolt 7 and the mating thread element 9 is loosened so that the two tensioning heads 5, 6 can be moved independently of one another. The clamping band 2 can then be bent open in order to be guided past flanges of a coned flange connection that has yet to be formed. The two tensioning heads 5, 6 are subsequently moved towards one another again, and the threaded bolt 7 is engaged with the mating thread element 9. If the threaded bolt 7 and the mating thread element 9 are then rotated towards one another, the two tensioning heads 5, 6 are moved towards one another. The inner diameter of the clamping band 2 is thereby decreased and the flanks 3, 4 are also moved radially inwards. Because of their pitch, they can apply an axial force on coned flanges not illustrated in greater detail, as is known per se.

However, the two tensioning heads 5, 6 can only be moved towards one another as far as the spacer piece 10 allows. Once the two tensioning heads 5, 6 bear against the spacer piece 10, a further decrease in the inner diameter of the profile clamp is no longer possible. In the case of a proper sizing, however, this is also not necessary.

The spacer piece 10 nevertheless has the advantage that the threaded bolt 7 and the mating thread element 9 can be screwed together to the limit, In addition, the spacer piece 10 creates a sufficient distance between the head 8 and the mating thread element 9. Within this distance, the threaded bolt 7 can expand according to its spring constants, in order to produce the necessary tension force. In the case of a sufficient tension force, the screw connection between the threaded bolt 7 and the mating thread element 8 is secured against a loosening.

As can be seen in FIG. 3, the tensioning heads 5, 6 are embodied in cross section in a U shape as viewed from the radially outer side. However, they are open in a radially outward direction, that is, they do not comprise on their radially outer ends any elements which face one another. This provides advantageous conditions for cost-effective production. However, the U shape of the tensioning heads 5, 6 offers the possibility of retaining the spacer piece in a predefined position and securing the spacer piece against a rotation relative to the tensioning heads 5, 6. This becomes evident from the schematic cross-section view in FIG. 4. Here, it can be recognized that the spacer piece 10 is embodied as a bent metal sheet part in which a metal sheet has been given a polygonal shape in cross section. The metal sheet is closed around the threaded bolt 7 in a circumferential direction. Only a butt seam 11 remains.

With the rectangular shape, it is possible to fit the spacer piece 10 into the U shape of the tensioning heads 5, 6,

Of course, deviations from the illustrated rectangular shape or square shape are possible. The spacer piece 10 can also have a different polygonal shape.

FIG. 5 shows a modified form of the spacer piece 10. Here, the radial inside of the spacer piece 10 has sloped flanks 13, 14. The shape and position of the flanks 13, 14 can be adapted to the shape and position of the flanks 3, 4 of the clamping band 2, so that an axial tension force can also be applied to the coned flanges in the region of the threaded bolt, which force can be applied by the flanks 13, 14 of the spacer piece 10.

FIG. 1 shows the profile clamp 1 in a fully installed state, in which the tensioning heads 5, 6 bear against the spacer piece 10 from both sides.

FIG. 6 shows a modified embodiment of the tensioning heads 5, 6 during tightening. The tensioning heads 5, 6 are angled relative to the clamping band 2 such that they are pitched towards the spacer piece 10 with their radial outsides. If the threaded bolt 7 and the mating thread element 9 are subsequently rotated towards one another, then the radial outsides or ends of the tensioning heads 5, 6 initially come to bear against the spacer piece 10. In a further tightening, that is, in a further rotation of the threaded bolt 7 and the mating thread element 9 towards one another, the radially inner ends of the tensioning heads 5, 6 draw closer to one another. In this manner, it is possible to introduce a relatively large tension force into the clamping band 2,

In a modified embodiment not shown, it can be provided that the spacer piece 10 is arranged on the outside of a tensioning head 5, 6. It is also possible to use multiple spacer pieces, which can then be arranged on the outsides of both tensioning heads 5, 6. In this case, the spacer piece or spacer pieces provide(s) a sufficiently large tensioning length, so that the threaded bolt 7 can expand according to its spring constants.

A modification of the embodiment according to FIG. 6 can be achieved in that the tensioning heads 5, 6 are aligned parallel to one another when they bear against the spacer piece 10, while the front faces of the spacer piece 10 (or at least one front face) are beveled radially inwards such that the same effect occurs during tightening as described in conjunction with FIG. 6. In this case, it can be advantageous if a wedge-shaped disc is arranged between the head 8 and the tensioning head 5 and/or between the mating thread element 9 and the tensioning head 6, so that in the tightened state, the head 8 and/or the mating thread element 9 act on surfaces that are directed perpendicular to the tightening direction.

Preferably, the spacer piece 10 is connected captively to a tensioning head 5. One option to achieve this is to embody the spacer piece 10 and the tensioning head as a single piece. This can be achieved, for example, in that the spacer piece 10 is bent out from an extension of the tensioning head 5.

An alternative embodiment is illustrated in FIG. 7. Here, the spacer piece 10 comprises a hook 15 that is guided through an opening 16 in the tensioning head 5. The opening 16 can, for example, be arranged radially outside the threaded bolt 7. if the threaded bolt 7 is then guided through the tensioning head 5 and through the spacer piece 10, then the spacer piece 10 is also held captively on the tensioning head 5. Likewise, a retaining ring, for example, a plastic ring, can also be fitted onto the threaded bolt 7 in order to hold the threaded bolt 7 captively inside the spacer piece 10.

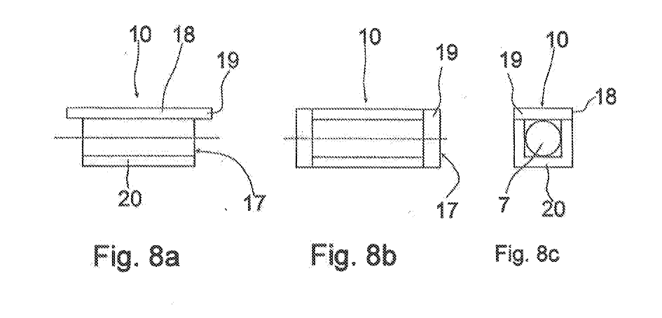

FIG. 8 shows a modified embodiment of a spacer piece 10, namely in a side view in FIG. 8a, in a top view from the radially outer side in FIG. 8b, and from a front face in FIG. 8c,

In the side view according to FIG. 8a, it can be seen that the spacer piece 10 comprises a front face 17, into which a radially outer wall 18 protrudes with a projection 19. The radially outer wall 18 is thus longer than a radially inner wall 20 in a circumferential direction, that is, in a direction between the two tensioning heads 5, 6. It is thus possible, by simple means, to embody the front face 17 in a stepped manner.

In any case, it is advantageous if the spacer piece 10 has a length that is equal to at least five times the nominal diameter of a threaded section of the threaded bolt 7. It can thus be ensured that the threaded bolt 7 has a sufficient clamping length.

1. Profile clamp (1) with an annular clamping hand (2) that comprises on its axial ends flanks (3, 4) sloped radially inwards and in the region of its circumferential ends respectively one tensioning head (5, 6), wherein the tensioning heads (5, 6) can be tightened towards one another by a head (8) of a threaded bolt (7) and a mating thread element (9), characterized in that at least one spacer piece (10) is arranged between the head (8) and the mating thread element (9).

2. Profile clamp according to claim 1, characterized in that the spacer piece (10) surrounds a threaded section of the threaded bolt (7).

3. Profile clamp according to claim 1, characterized in that the spacer piece (10) is arranged between the tensioning heads (5, 6).

4. Profile clamp according to claim 3, characterized in that the spacer piece (10) comprises on its radially inner side flanks (13, 14) sloped radially inwards.

5. Profile clamp according to claim 3, characterized in that in the untightened state, at least one tensioning head (5, 6) is tilted relative to the spacer piece (10) such that it initially comes to hear against the spacer piece (10) on the radially outer side during tightening.

6. Profile clamp according to claim 3, characterized in that at least one tensioning head (5, 6) is embodied in an open manner on the radially outer side.

7. Profile clamp according to claim 1, characterized in that the spacer piece (10) is arranged on the outside of a tensioning head (5, 6).

8. Profile clamp according to claim 1, characterized in that the spacer piece (10) is embodied as a bent metal sheet part.

9. Profile clamp according to claim 8, characterized in that the spacer piece (10) has a polygonal cross section.

10. Profile clamp according to claim 1, characterized in that the spacer piece (10) is connected to a tensioning head (5, 6).

11. Profile clamp according to claim 10, characterized in that the spacer piece (10) is formed from the tensioning head (5).

12. Profile clamp according to claim 10, characterized in that the spacer piece (10) is hooked into the tensioning head (5).
